(19) United States
(12) Patent Application Publication
(10) Pub. No.: US 2021/0172663 A1
(43) Pub. Date: Jun. 10, 2021

(54) HVAC SYSTEM REPAIR METHOD AND APPARATUS

(71) Applicants: Richard Dort, Berwyn, IL (US); Mark D. Runyan, Berwyn, IL (US)

(72) Inventors: Richard Dort, Berwyn, IL (US); Mark D. Runyan, Berwyn, IL (US)

(21) Appl. No.: 17/269,652

(22) PCT Filed: Aug. 21, 2019
(86) PCT No.: PCT/US2019/047493

§ 371 Date: Feb. 19, 2021

Related U.S. Application Data
(60) Provisional application No. 62/765,359, filed on Aug. 21, 2018.

(51) Int. Cl. F25B 45/00; B08B 9/032

(52) U.S. Cl. CPC F25B 45/00; F25B 2345/002; F25B 2345/006; B08B 9/0325

(57) ABSTRACT

A method and device for flushing an HVAC line, wherein an output line from a manifold is inserted into an HVAC service line and a first medium is connected to a first input line connected to the manifold and a second medium is connected to a second input line connected to the manifold. The flow of the first medium into the manifold using a first valve and/or flow of the second medium into the manifold using the second valve so that the first medium and/or second medium are selectively provided to the manifold and exit the manifold and enter the HVAC service line through the output line, and the outflow of the first medium and/or second medium out of the HVAC service line is monitored.

### RELATED APPLICATIONS

The present application claims priority to U.S. Provisional Patent Application No. 62/765,369 filed Aug. 21, 2018, the contents of which are incorporated herein by reference.

### FIELD OF THE INVENTION

The present invention generally relates to heating, ventilation, and air conditioning (“HVAC”) and/or cooling or refrigeration systems. The present invention more specifically relates to HVAC or refrigeration maintenance and repair and HVAC flushing solvents, methods, processes and devices that provide improved flushing and/or repair of HVAC or refrigeration systems using flushing solvents.

### BACKGROUND OF THE INVENTION

Residential and commercial HVAC systems control the temperature, humidity and total air quality in countless buildings around the world. These systems, which include air conditioners, heat pumps and other heating, ventilation and air conditioning systems require a significant amount of maintenance. Since HVAC systems often operate under extreme conditions, HVAC failures are common and maintenance is required. In addition, to prevent or minimize such failures, routine or preventive maintenance is performed on most commercial and residential HVAC systems.

When a contractor visits a job site, the con tractor must first perform an assessment of potential problems within an HVAC system. Common HVAC system problems include a burned-out compressor, a clogged condenser, line set, or capillary line, and/or a system leak. Fixing diagnosed problems and performing preventive maintenance may require a number of parts or chemicals, making it difficult to arrive at each HVAC system with all potentially required elements.

When converting or replacing refrigerant, it is standard procedure to flush line sets using flush solvents and/or nitrogen. System flushing solvents are used to remove old refrigerant and other contaminants from refrigeration compressor systems, including HVAC systems. The need to remove old refrigerant and other contaminants from the HVAC systems results from two primary circumstances, refrigerant retrofit and compressor burnout. Before an HVAC system can be retrofit by charging the HVAC system with a new, environmentally friendly refrigerant, the old refrigerant and any other contaminants m the HVAC system must be removed. Where a condenser or compressor fails or becomes otherwise damaged, the old refrigerant and contaminants in the HVAC system must be removed before the compressor system can be recharged with fresh refrigerant.

When using flushing solvents, the solvents are placed into the HVAC lines or line sets. The lines may have different diameters, with lines having different diameters potentially being used in a single HVAC system. These lines, and specifically the smaller diameter more narrow lines which are commonly referred to as capillary lines, will often end up accumulating buildup of fluids and/or corrosion that can form a clog within the lines and prevent the proper flushing of lines.

Various forms of chemical structures may be used as a “flush” solvent. Some of these flush solvents are designed to remove or emulsify any residual or burnt oil, refrigerant, contaminants or buildup from lines or line sets. These solvents may be sold or utilized in pressurized canisters having a predetermined and limited pounds per square inch (PSI) pressure within the can to force the solvent out of the can and into the line. Alternatively, the solvent may be sold as a liquid in a bottle that is then required to be poured into a canister and/or flush tank, with the solvent being pressurized with nitrogen by an end user. Once placed in the canister with the nitrogen or other pressurizing element, the solvents are again placed at a predetermined and limited PSI based on the size of the tank or container. In either case, the solvent is typically pressurized in the container to less than 100 PSI, and more commonly to less than 50 PSI.

In current practice, the flush process consists of a one or two-step process depending on the nature of the clog or damage to the line. In the first step, a flush solvent is first suppled into the line, with the only nitrogen used to pressurize the solvent and force it through the line being that contained in the solvent container. If the pressurized flush solution is not sufficient enough to pass through and clean the line set and remove clogs and/or other contaminants a second step is required in which the line is opened and pressurized nitrogen is introduced into the line. The higher-pressure nitrogen is introduced into the line in a controlled manner to attempt to force the residual flush solvent, contaminants, blockages and/or clogs out the end of the line. This higher-pressure nitrogen purge process is done at a higher PSI rating than the PSI in the solvent container, for example, in order to force the flush solvent through the line and push out any clogs or residual elements.

While the second step may provide the necessary pressure to flush the line completely, when the line set is opened to introduce the high pressure nitrogen for the purge process, at least a portion of the flush solvent that was previously introduced into the line escapes or evaporates from the line set before the higher pressure nitrogen can be introduced at a desired and controlled level. Such results in inefficient line purging and increased costs for HVAC system owners.

Furthermore, when clogging or damage occurs to capillary lines within an HVAC unit or system, it is standard practice to replace, rather than flush and repair, the capillary lines. Replacing the capillary lines is labor intensive, difficult procedure which requires finding the clog or damage, opening the system, cutting out a section of the tube, and replacing the section of the tube. Depending on the location of the damage or clog, additional lines or system components may require removal to access the portion of the capillary line which must be replaced.

Accordingly, it would be advantageous to have a system and method whereby in a single step, flush solvent can be introduced at varying, controlled pressures in a single step, without having to open the line to increase the pressure of previously introduced flush solvent before increasing the pressure.

It would be further advantageous if such a system could be used to unclog and repair capillary lines when they become damaged and/or clogged, rather than having to remove and replace such lines within an HVAC system.

The present invention is provided to solve these and other problems.

### SUMMARY OF THE INVENTION

The present invention is directed to a method and device for flushing an HVAC line, wherein flush solvent and a pressurizing medium can be simultaneously and supplied to and pushed through the HVAC line in selective amounts without having to disconnect the supply from the HVAC line.

According to one aspect of the invention, a method for flushing an HVAC line is provided wherein an output line from a manifold is inserted into an HVAC service line, a first medium is connected to a first input line connected to the manifold, and a second medium is connected to a second input line connected to the manifold. The flow of the first medium into the manifold is controlled using a first valve and/or flow of the second medium into the manifold is controlled using a second valve, wherein the first medium and/or second medium are selectively provided to the manifold and exit the manifold and enter the HVAC service line through the output line. Outflow of the first medium and/or second medium out of the HVAC service line may be monitored to insure medium is flowing through the HVAC service line and/or the status of the maintenance being performed on the HVAC service line.

The flow pressure of the first medium entering the HVAC service line may be selectively controlled by controlling the flow of the second medium—that is the second medium may be used to pressurize the first medium in the manifold and the output line. In order to provide better pressure control, the flow pressure of the first medium entering the HVAC service line may be sensed. If there is low, or no, outflow from the HVAC service line, the first medium may be further pressurized by increasing the flow of the second medium entering the manifold.

According to another aspect of the invention, a line coupler may be connected to an end of the output line before inserting the output line into the HVAC service line. The output line has a first diameter and the line coupler has a second diameter, wherein the first diameter and second diameter are different, with the extension providing a proper interface—either larger or smaller—between the output line and the HVAC service line. Such an extension may be used to mate the output line to a capillary line, for example, to introduce the first and/or second medium to the capillary line to clean and repair the capillary line rather than replacing it.

According to another aspect of the invention, backflow of the first medium and/or second medium from the manifold, the output line, and the HVAC service line into the first input line and second input line may be prevented using check valves or similar one-way flow devices.

According to another aspect of the invention, the first medium may be a flush solvent and/or the second medium may be nitrogen. Regardless of what the first and second mediums are, both the first medium and second medium may be provided to, and exit from, the manifold simultaneously.

According to one aspect of the invention, a device for flushing an HVAC line is provided. The device has a manifold comprising a housing surrounding a mixing area, a first input, a second input, and at least one output, wherein each input includes an inlet coupling for fixing an inlet line to the manifold, and the at least one output includes an outlet coupling for fixing an outlet line to the manifold. The device further includes a first valve for connecting the first input to a first input line, and a second valve for connecting the second input to a second input line. The device may further include at least two check valves, wherein a first check valve is coupled between the first valve and the first input, and a second check valve is connected between the second valve and the second input.

The device may also include a line coupler, the line coupler being connected an end of the output line. Where the device includes a line coupler, the output line may have a first diameter and the line coupler may have a second diameter, with the first diameter and the second diameter being different so that the extension insures a proper coupling to an HVAC line.

The device, or a HVAC flushing system utilizing the device, may further include a first medium source containing a first medium with the first medium source being connected to an end of the first input line. The first valve may control flow of the first medium into the manifold. The first medium may be a flush solvent.

The device, or a HVAC flushing system utilizing the device, may also include a second medium source containing a second medium with the second medium source being connected to an end of the second input line. The second valve controls flow of the second medium into the manifold. The second medium may be nitrogen. Regardless of what the first medium and second medium are, the second medium may pressurize fluid exiting the manifold through the output line, i.e. the first medium and/or a combination of the first medium and the second medium.

The device may include a sensor, wherein the first medium and/or second medium exit the manifold through the output line and the sensor monitors the pressure of the first medium and/or second medium in the output line. Any required gauges may be fixed to the sensor in order for an end user to monitor and control the pressurization of the fluid exiting the manifold through the output line.

Other advantages and aspects of the present invention will become apparent upon reading the following description of the drawings and detailed description of the invention.

### BRIEF DESCRIPTION OF THE DRAWINGS

FIG. 1 shows a schematic view of a preferred embodiment of the invention;

FIG. 2 shows a close-up view of portion A in FIG. 1; and

FIG. 3 shows an embodiment of a manifold of the invention.

### DETAILED DESCRIPTION OF THE PRESENT INVENTION

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

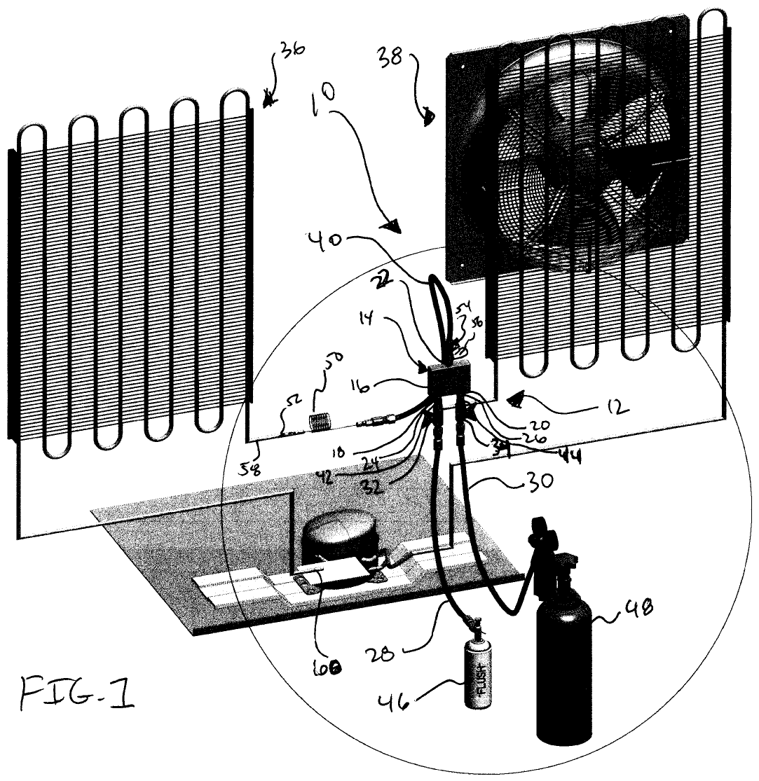

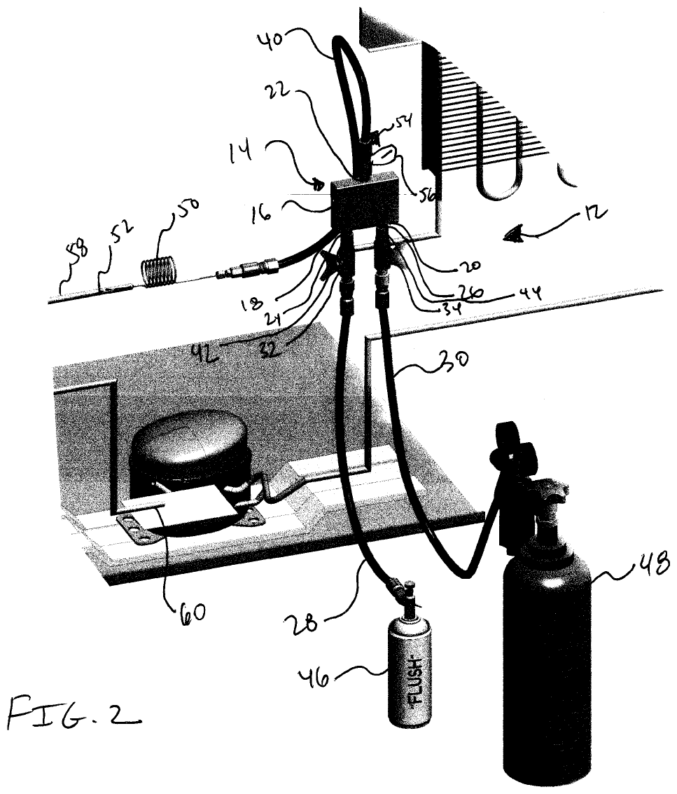

FIGS. 1 and 2 show an exemplary device and system for maintaining and repairing an HVAC system as contemplated by the present invention. Though discussed as an HVAC system herein, it should be understood that in addition to HVAC systems, the device, system, and method of the present invention may be used with similar heating and/or cooling systems, like for example refrigeration systems which use condensers, compressors, and/or evaporators. Though the device and method will be discussed primarily in conjunction with use with an HVAC system, it should be understood that the same method and device may be utilized to maintain and repair refrigeration devices and systems in substantially the same manner as HVAC systems as discussed herein.

As seen in FIGS. 1 and 2, repair and maintenance system 10 includes a device 12 which has a manifold 14 having a body or housing 16, a first input 18, a second input 20, and at least one output 22. Each input 18, 20 includes a coupling 24, 26 respectively, for fixing a first and second input line 28, 30 to the first and second inputs, respectively. The device 12 further includes a first valve 32 connecting the first input line 28 to the first coupling 24 and manifold 14, and a second valve 34 connecting the second input line 30 to the second coupling 26 and manifold 14. First and second valves 32, 34 have a primary purpose of controlling any mediums or fluids provided to and through the manifold to a connected HVAC or refrigeration system 36 or 38 for example. Valves 32, 24 may be any valves capable of controlling fluid flow, including but not limited to gate valves, globe valves, pinch valves, diaphragm valves, needle valves, or ball valves.

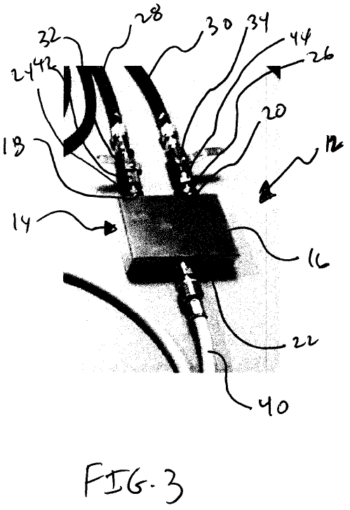

As can be seen in FIGS. 1 and 2, and most clearly seen in FIG. 3, in order to prevent backflow from the HVAC or refrigeration system 36 or 38, output line 40, and/or manifold 14, each of the first coupling 24 and second coupling 26 may include a check valve 42, 44 respectively. By utilizing a check valve, any medium which is provided to the manifold 14 and HVAC or refrigeration system will remain within device 12 and/or system when a change in medium or additional medium is required. For example, if first input line 28 is connected at one end to a first medium source 46 which may contain a flushing solvent, and second input line 30 is connected at one end to a second medium source 48 containing a pressurizing medium or agent such as nitrogen, first check valve 42 will prevent any flushing solvent immediately introduced to the system through manifold 14 and output line 40 from escaping the system or manifold if pressurization through the second input line is required.

In current HVAC maintenance and repair systems, once flushing solvent is introduced, if additional pressurization is required, the flushing solvent line must be disconnected from the system and the pressurization line connected in its place. When the flushing solvent line is disconnected, this causes some or all of the flushing solvent which has already been introduced into the line to evaporate, leak, or otherwise escape out of the line, wasting that solvent which has already been used. Since both the first input 18 and second input 20 of device 12 having an independently controllable valve (32 and 34 respectively), the present invention makes it possible for two separate mediums, flushing solvent and a pressurizing medium like nitrogen for example, to be supplied to a connected HVAC system simultaneously or in sequence without losing or wasting any previously provided medium to the system. With two controllable inputs, each having a check valve, the present invention keeps all of the previously introduced solvent in the line, and provides a means, second valve 34 for example, for controllably increasing the pressure of the introduced solvent without ever disconnecting the device from the HVAC system and any line sets or capillary lines causing the introduced solvent to evaporate and leak out.

In order to provide coupling for output line 40 to capillary lines within system 36 or 38, as seen in FIGS. 1 and 2, device 12 may include an optionally connectable line coupler 50 which has a smaller diameter at least at its output end 52 than the diameter of output line 40. Providing the smaller diameter coupler allows for the first and second mediums, for example, to be supplied into and force through capillary lines to repair and maintain such lines, rather than having to replace clogged or damaged lines. Of course, rather than having a smaller diameter as shown in FIGS. 1 and 2, it is contemplated that where larger diameter set lines or system lines are encountered, a second or alternative coupling device may be provided or utilized which has a larger diameter than the output line to insure that larger diameter set lines or system lines can likewise be maintained and repaired using the device.

In order to better control the pressure and monitor the pressure in the line to prevent breakages within the HVAC system, a sensor 54 may be provided to monitor the pressure of either the first or second medium, or a combination of the first and second medium, exiting the manifold 14 into output line 40. The sensor may be connected to each of valves 32, 34 and configured to close or partially close one or both valves if a pressure limit is reached. A pressure limit may be set, for example, from system to system or line to line within a system in order to prevent further damage to the HVAC system and lines. A pressure gauge 56 may be provided along with in place of sensor 54 so that the pressure can be manually monitored and adjusted when performing maintenance or repairs on an HVAC system utilizing the device.

In operation, the present device and system may be used as follows.

When maintenance or repair is required in an HVAC system related to one or more of the line sets or system lines, outlet line 40 of device 12 may be connected to a line set or system line 58 as seen in FIG. 1. The outlet line may be connected directly, as is, to the line set or system line, or may first have a line coupler increasing or decreasing the size of the diameter of the outlet line attached, with the line coupler being connected to the line set or system line.

Before, at the same time, or after device 12 and output line 40 are connected to an HVAC system, each of the first input 18 and the second input 20 are connected to medium sources 46 and 48 by first input line 28 and second input line 30, respectively. The first medium may be, for example, a flushing solvent, while the second medium is a pressurizing medium such as nitrogen.

Any flushing solvent may be utilized with the present invention, with flushing solvents typically being formulated to have low toxicity, low emissions of volatile organic compounds (VOCs), low global warming potential, improved varnish cutting capability, and improved water absorption. Flushing solvents typically include some combination of hydrofluoroether, acetone, t-butyl acetate and trans 1,2 dichloroethylene. The relative amounts of each chemical constituent can be formulated to accomplish degreasing and varnish penetration within damaged or clogged lines. The relative amounts generally include 1-40% hydrofluoroether, 1-40% acetone, 1-40% t-butyl acetate and 20-70% trans 1,2 dichloroethylene. The flushing solvents may be packaged in a kit, for example in a container, along with one or more of a charging hose, clip-on funnel, and injector trigger nozzle. A reusable tank can also be included.

A pressurizing medium which is typically used is Nitrogen gas (N₂), however other pressurized inert gasses may be utilized in its place, such as Argon (Ar).

Each of the first and second input lines 28, 30 may connect to the respective first and second input 18, 20 of manifold 14 at first and second valves 32, 34. When connected, each valve should be turned to the off position, with the valves remaining in the off position until flushing and/or pressurization is ready to occur. Of course, it is contemplated by the invention that no first and second valves are provided, and instead valves at the first and second medium sources may be utilized to control the amount of the first and/or second medium which is input into the HVAC system through device 12.

When flushing is set to begin, the first valve 32 may be partially or fully turned to the on position to allow the first medium, the flushing solvent, to being flowing through manifold 14 and outlet line 40 into system line 58 of the HVAC or refrigeration system. A return line 60 may be provided as part of system 10, through which flushing solvent may exit the HVAC system and may be observed and monitored. In instances where the clog or damage is minor, flushing may be seen flowing out of the return line shortly after flushing begins, with flushing solvent being continually provided until the flushing solvent returned through return line 60 becomes clear or the color and consistency of the flushing solvent used to flush the system, at which time the first valve may be closed with the line being cleared and operational.

Where only a slow trickle or no flushing solvent is observed leaving the HVAC system through return line 60, the flushing medium may begin being pressurized by moving the second valve to a partially open position to begin pressurizing the flushing solvent with the second medium, like Nitrogen. The opening of the second valve may be done in conjunction with closing the first valve to stop the flow of flushing solvent into the HVAC system until the clog or blockage is opened, or may be done simultaneously with supplying flushing solvent to further build pressure in the system and provide immediate further flushing solvent once the blockage is cleared. In order to allow for the simultaneous insertion of the first and second medium into the HVAC system, manifold 14 may act as a mixing chamber in which the Nitrogen, for example, mixes with and pressurizes the flushing solvent as it pass through and out the manifold through outlet 22 and outlet line 40.

To monitor the amount of pressure being provided by the second medium as its supply begins, sensor 54 and/or gauge 56 may be provided so that a desired pound-per-square inch (“PSI”) pressure level is reached and/or a PSI pressure limit is monitored to attempt to prevent damage to the line. By using valves and a gauge or sensor, a controlled increase in pressure can be accomplished while monitoring the total pressure in the line so that further damage can be avoided.

In order to ensure that the pressure builds in manifold 14, outlet line 40, and HVAC system line 58, each of the first input and second inputs 18, 20 may include check valves 42, 44. Check valve 42, for example, not only prevents backflow of flushing solvent if a blockage or some line damage prevents the flow of flushing solvent through system line 58, it also helps ensure that the flushing material remains in the line and becomes pressurized once pressurization begins. Since a single manifold is used to deliver both flushing solvent and a pressurizing medium like Nitrogen, the only way for flushing solvent to exit the system in response to a blockage or pressurization is through the inlet line. Check valve 42 prevents this back flow.

Pressurizing of the flushing solvent is further insured by the use of check valve 44 which prevents the second medium from being pushed out of the system as pressure builds. The use of check valves 42, 44 ensure that all flushing solvent and pressurizing medium remains in the system until the outlet line is disconnected, preventing waste and maximizing the efficiency of any maintenance and/or repair.

Once the blockage is cleared, the second valve can be closed with only flushing solvent once again being provided in the system. If further blockages are met within the line, the first valve can again be closed and/or the second valve can be opened in order to provide further pressure to push through each blockage. Once all blockages have been cleared and flushing solvent is detected at the return line, the second valve can be closed completely, and only flushing solvent provided through the system line until the flushing solvent returned through return line 60 becomes clear or the color and consistency of the flushing solvent used to flush the system, at which time the first valve may be closed with the line being cleared and operational.

In the instance of severe damage or sever blockage within system line 58, it may be necessary to evacuate the system line, outlet line, and manifold and restart the procedure and/or replace the system line. The use of a sensor or gauge may indicate that the blockage is particularly bad based on the PSI in the line, for example, and provide sufficient indication to close off the second medium and clear the line, or in the case of a sensor, may dynamically close the second valve and open the device to drain all of the first or second medium in response to a pressure threshold being reached.

In order to control the valves, device 12 may include internally, or be connected externally, to a controller which opens and closes the valves in response to signals received from the pressure sensor. Such a controller may be used to dynamically begin pressurizing the line when no flushing solvent is detected exiting the return line, for example. The controller may hold or begin dynamically closing the second valve in response to pressure thresholds being reached as sensed by the pressure sensor in order to avoid damage to the system. Where clearing of the line is required, the controller may be further configured to dynamically open any check valves and/or any other valves or evacuation means to allow the system line and manifold to be cleared.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

1. A method for flushing a heating, ventilation or air conditioning (“HVAC”) line, the method comprising:
inserting an output line from a manifold into an HVAC service line;
connecting a first medium to a first input line connected to the manifold;
connecting a second medium to a second input line connected to the manifold;
controlling flow of the first medium into the manifold using a first valve and/or flow of the second medium into the manifold using the second valve, wherein the first medium and/or second medium are selectively provided to the manifold and exit the manifold and enter the HVAC service line through the output line; and
monitoring outflow of the first medium and/or second medium out of the HVAC service line.

2. The method of claim 1, wherein flow pressure of the first medium entering the HVAC service line is selectively controlled by the controlling of flow of the second medium.

3. The method of claim 2, further comprising the step of sensing the flow pressure of the first medium entering the HVAC service line.

4. The method of claim 2, further comprising the step of increasing the flow pressure of the first medium by increasing the flow of the second medium entering the manifold if there is no outflow of the first medium and/or second medium from the HVAC service line.

5. The method of claim 1, further comprising the step of attaching a line coupler to an end of the output line before inserting the output line into the HVAC service line.

6. The method of claim 5, wherein the output line has a first diameter and the line coupler has a second diameter, wherein the first diameter and second diameter are different.

7. The method of claim 1, further comprising the step of preventing backflow of the first medium and/or second medium from the manifold, the output line, and the HVAC service line into the first input line and second input line.

8. The method of claim 1, wherein the first medium is a flush solvent.

9. The method of claim 1, wherein the second medium is nitrogen.

10. The method of claim 1, wherein both the first medium and second medium are provided to the manifold simultaneously.

11. A device for flushing an HVAC line, the device comprising:
a manifold, the manifold comprising a housing surrounding a mixing area, a first input, a second input, and at least one output, wherein each input includes an inlet coupling for fixing an inlet line to the manifold, and the at least one output includes an outlet coupling for fixing an outlet line to the manifold;
a first valve for connecting the first input to a first input line; and
a second valve for connecting the second input to a second input line.

12. The device of claim 11, further comprising at least two check valves, wherein a first check valve is coupled between the first valve and the first input, and a second check valve is connected between the second valve and the second input.

13. The device of claim 11, further comprising a line coupler, the line coupler being connected an end of the output line.

14. The device of claim 13, wherein the output line has a first diameter and the line coupler has a second diameter, wherein the first diameter and the second diameter are different.

15. The device of 11, further comprising a first medium source containing a first medium, the first medium source being connected to an end of the first input line, wherein the first valve controls flow of the first medium into the manifold.

16. The device of claim 15, wherein the first medium is a flush solvent.

17. The device of claim 11, further comprising a second medium source containing a second medium, the second medium source being connected to an end of the second input line, wherein the second valve controls flow of the second medium into the manifold.

18. The device of claim 17, wherein the second medium is nitrogen.

19. The device of claim 17 wherein the second medium pressurizes fluid exiting the manifold through the output line.

20. The device of any of claim 15, further comprising a sensor, wherein the first medium and/or second medium exit the manifold through the output line and the sensor monitors the pressure of the first medium and/or second medium in the output line.
